(19) United States
(12) Patent Application Publication
(10) Pub. No.: US 2003/0213854 A1
(43) Pub. Date: Nov. 20, 2003

(54) EVAPORATOR CONFIGURATION FOR A MICRO COMBINED HEAT AND POWER SYSTEM

(76) Inventors: George H. Stickford, Dublin, OH (US); William T. Hanna, Gahanna, OH (US); Donald Anson, Worthington, OH (US)

Correspondence Address: Killworth, Gottman, Hagan & Schaeff, L.L.P., One Dayton Centre, Suite 500, Dayton, OH, 45402-2023, US

(21) Appl. No.: 10/145,643

(22) Filed: May 15, 2002

(51) Int. Cl. B60H 1/02

(52) U.S. Cl. 237/12.1

(57) ABSTRACT

An evaporator for a micro combined heat and power system. The evaporator includes a heat source, an enclosure with a heating chamber and a primary fluid flowpath, and tubing that can carry a working fluid through a secondary fluid flowpath that intersects the primary fluid flowpath. The tubing is grouped into stages, including a first, or proximal, stage situated closest to the heat source, a second, or intermediate, stage downstream of the heat source relative to the proximal stage, and a third, or distal, stage downstream of the heat source relative to the proximal and intermediate stages. The stages of the evaporator tubing, while preferably circuited in a hybrid co-flow and counterflow arrangement, can also be used with purely co-flow or purely counterflow configuration. The proximal stage can be made from a first, relatively robust material, while the distal stage can be made from a second, relatively high thermal conductivity material. The intermediate stage can be made from either the first material or the second material, depending on the application. At least the distal stage includes heat transfer augmentation structure, which can take the form of fins and related componentry.

### BACKGROUND OF THE INVENTION

The present invention generally relates to improvements in operability and efficiency of a Rankine cycle cogeneration system using an organic working fluid, and more particularly to an improved evaporator used to produce superheated vapor from the organic working fluid.

The concept of cogeneration, or combined heat and power (CHP), has been known for some time as a way to improve overall efficiency in energy production systems. With a typical CHP system, heat (usually in the form of hot air or water) and electricity are the two forms of energy that are generated. In such a system, the heat produced from a combustion process can drive an electric generator, as well as heat up water, often turning it into steam for dwelling or process heat. Traditionally, CHP systems have been large, centrally-operated facilities under the control of the state or a large utility company, sized to provide energy for many thousands of users. If the region being served by the CHP has as part of its infrastructure adequate heat transporting capability, the centrally-generated heat and electric power model of the large CHP system can, within limits, function reasonably efficiently and reliably. In the absence of adequate heat transport capability, however, while the region's electric power needs would continue to be met by the central generating station, the heat needs would need to be fulfilled separately and remotely from the electricity production, often near or within the building housing the end-user. This latter configuration typically includes the presence of one or more boilers that could generate hot water or steam to provide most or all of the localized building heating requirements. While either configuration works well for its intended purpose, inefficiencies arise. In the former system, much of the heat generated at the central generating station is, after being transported over long distances, unavailable for remote use. In the latter system, the lack of CHP capability necessitates the consumption of additional energy at the remote location to satisfy heat requirements.

Recent trends in the deregulation of energy production and distribution have made viable the concept of distributed generation. With distributed generation, the large, central generating station is supplemented with, or replaced by numerous smaller autonomous or semi-autonomous units. These changes have led to the development of smaller CHP systems, called micro-CHP, which are distinguished from traditional CHP by the size of the system. By way of contrast, the electric output of a generating station-sized CHP could be in the tens, hundreds or thousands of megawatts (MW), where the electric output of a micro-CHP is fairly small, in the low kWₑ or even sub-kWₑ range. The inclusion of a distributed system into dwellings that already have fluid-carrying pipes for heat transport is especially promising, as little or no disturbance of the existing building structure to insert new piping is required. Similarly, a micro-CHP system's inherent multifunction capability can reduce structural redundancy. Accordingly, the market for localized heat generation capability in Europe and the United Kingdom (UK), as well as certain parts of the United States, dictates that a single unit for residential and small commercial sites provide heat for both space heat (SH), such as a hydronic system with radiator, and domestic hot water (DHW), such as a shower head or faucet in a sink or bathtub, via demand (instantaneous) or storage systems.

As with all energy production devices that rely on non-renewable sources, such as natural gas, coal or oil, a more efficient system consumes lower quantities of fuel to generate the same energy output as its less efficient counterpart. A key factor in keeping micro-CHP system efficiency high over a wide range of operating conditions is how much thermal output is required at the heat source, such as a natural gas burner. Unfortunately, the nature of micro-CHP system operation, where both electric power and heat are generated from the same combustion process often under a fixed heat to power (Q/P) ratio, is such that when thermal output is reduced to minimize fuel consumption, the electric power production often drops even more quickly. As such, these systems cannot operate efficiently when climatic changes and user energy-consumption habits deviate significantly, over the course of a day or the year, from the rated Q/P. With a fixed Q/P heat-led system, because the electric power output follows heat production, a significant turndown in thermal load results in a concomitant loss in electric output, and because maximizing system efficiency is typically a corollary to maximizing electric output, such part power operation severely limits the benefits associated with cogeneration systems.

In a Rankine cycle, as well as other power-producing cycles, energy (often in the form of heat from a combustion process) is transferred to a working fluid that, through appropriate machinery, can produce useable mechanical, electrical or thermal output. The overall efficiency in converting the heat of a combustion process is strongly influenced by the efficiency of the evaporator, where typically a natural gas or oil fired burner heats the working fluid until the fluid undergoes a state change. In such an evaporator, heat exchanger tubes carry the working fluid past the exhaust gas (alternately referred to as a flue gas) or flames generated at the burner such that the working fluid is evaporated, superheated, then transported to other system componentry in order to perform work. The efficiency of such a tube heat exchanger is usually limited by the heat transfer coefficient on the flue gas side of the heat exchanger, especially when the working fluid being heated inside the tube is a relatively high thermal conductivity liquid. Fins are typically added to the outside of the tubes to maximize surface area, so that the high temperature flue gases that bathe the tube can more readily give up their heat to the working fluid flowing through the inside of the tubes.

The heat exchanger tubes are often made from high thermal conductivity materials in order to maximize heat transfer through the tube wall and into the working fluid. Generally, copper provides the best combination of cost and thermal conductivity for tube heat exchangers. However, copper tubes may lack the strength and durability to withstand high internal pressure generated by the working fluid when changing from a liquid to a vapor, as well as the high flue gas temperatures experienced near the burner and flame, which can produce flue gas temperatures in excess of 2000° F. (1093° C.). At such temperatures, and at such high thermal conductivity through the tube walls, there is the additional potential for the working fluid and tube materials to become too hot. For example, when the working fluid is an organic working fluid, such as the refrigerant known as R-245fa, the maximum temperature of the working fluid should be kept under 350° F. (177° C.). More durable materials, such as stainless steel or superalloys, could be indiscriminately used, but such use, in addition to increasing system cost, may not provide adequate thermal conductivity in all regions of the heat exchanger tubing, which can limit the ability of the heat exchanger to perform its intended task. By having the working fluid pass first through the tubing nearest to the combustion process then later through the tubing remote from the combustion process (in what is called co-flow), the chance of overheating of the tubes or the working fluid inside is lessened; however, the efficiency of the evaporator suffers, as a significant amount of residual heat from the exhaust gas is not transferred to the working fluid because in this case, the hottest working fluid must still be able to draw heat from the coolest flue gas, thus limiting how low the exiting flue gas temperature can be. On the other hand, by having the working fluid pass first through the tubing remote from the combustion process then through the tubing nearest to the combustion process (in what is called counterflow), higher efficiency is produced, but is most likely to exceed temperature limits inherent in the tubing or working fluid. Absent a proper tube material or fin choice, both the co-flow and counterflow tube circuiting approaches are deficient in at least one aspect.

What is needed is a micro-CHP system that can accommodate variable Q/P requirements through advanced system componentry and improved fluid-circuiting design. The present inventors have recognized that such improvements to the evaporator can make important contributions to overall system efficiency, which in turn can enable a variable Q/P micro-CHP system. The present inventors have additionally recognized that even with traditional circuiting arrangements, such as the aforementioned co-flow or counterflow, the judicious use of proper materials and heat exchange fins can provide additional system benefits.

### BRIEF SUMMARY OF THE INVENTION

These needs are met by the present invention, where a micro-CHP system that employs a high efficiency evaporator is described. The inventors have discovered that the use of organic working fluid, rather than a more readily-available fluid (such as water) is important where shipping and even some end uses could subject portions of the system to freezing (below 32° F., 0° C.). With a water-filled system, damage and inoperability could ensue after prolonged exposure to sub-freezing temperatures. In addition, by using an organic working fluid rather than water, corrosion issues germane to water in the presence of oxygen, and expander sizing or staging issues associated with low vapor density fluids, are avoided. The organic working fluid is preferably either a halocarbon refrigerant or a naturally-occurring hydrocarbon. Examples of the former include the refrigerant known as R-245fa, while examples of the latter include some of the alkanes, such as isopentane. Furthermore, the present inventors have discovered that while the preferred heat source used to heat up the working fluid can be provided by a conventional combustion process, such as from a gas, coal, wood, biomass or oil burner or waste heat, it could come from other sources, including from an intermediate heat transfer loop, thus permitting indirectly-fired systems.

According to a first aspect of the present invention, an evaporator is disclosed. The evaporator includes a heat source configured to produce an elevated temperature primary fluid, an enclosure defining a primary fluid flowpath therein such that the primary fluid flowpath is in thermal communication with the heat source, and tubing disposed within the flowpath. The tubing is spaced relative to the heat source such that during operation of the heat source at least a portion of the heat generated is transferred to the tubing to vaporize and superheat an organic working fluid inside the tubing. The tubing is grouped into a number of stages along the flowpath such that as the elevated temperature primary fluid flows downstream from the heat source, it encounters sequentially a proximal stage, at least one intermediate stage and a distal stage. As used in the present context, a “stage” can be made up of as little as one tube pass across the primary fluid flowpath, or can be made up of multiple passes so long as all the tubes within that stage are subjected to substantially the same primary fluid temperature regime. The logical concomitant of this is that, in its most simplistic form, the evaporator could have but three individual tube passes and still be possessive of a proximal, intermediate and distal stage. Each successive stage encounters a lower temperature primary fluid regime than the immediately preceding stage. This allows one or more of the earlier stages to be made from tubing having little or no heat transfer augmentation. One or more of the later stages can be made of tubing with a small amount of heat transfer augmentation, which can take the form of fins or other surface area increasing componentry. Each subsequent stage can have increasing amounts of surface area for heat transfer augmentation. At least the distal stage can include the maximum amount of heat transfer augmentation structure. At least the distal stage includes heat transfer augmentation structure, which can take the form of fins and related componentry. Optionally, the proximal stage is defined by a substantially uniform outer surface along a longitudinal dimension thereof. In other words, the outer surface preferably contains no fins, projections or related surface undulations that would cause it to display other than a substantially cylindrical cross-section. As used in conjunction with the present disclosure, the term “substantially” refers to an arrangement of elements or features that, while in theory would be expected to exhibit exact correspondence or behavior, may, in practice embody something slightly less than exact. As an additional option, at least a portion of the intermediate stage can be equipped with fins. Preferably, such fins would be smaller relative to the size of the tubing to which they are attached than the fins on the distal stage, and the fin spacing may vary, with widely spaced fins on the tubes immediately following the proximal stage, and more closely spaced fins on subsequent stages.

According to another aspect of the invention, a cogeneration system is disclosed. The system includes a working fluid circuit and one or more energy conversion circuits operatively responsive to the working fluid circuit such that upon operation of the cogeneration system, the energy conversion circuit is configured to provide useable energy. In the present context, the term “useable energy” includes that which a user can put to practical use, rather than waste or incidental energy. The most notable examples of useable energy arising out of the operation of a cogeneration system are electricity (preferably alternating current electricity) and heat for processes or creature comfort such as DHW and SH. Accordingly, the energy conversion circuit can include equipment such as a generator (to convert mechanical power to electricity) and a circulating fluid medium (to recover and apply the heat remaining in the working fluid after the fluid has been expanded). By way of example, the circulating fluid medium can be a separate water loop that interacts with the condenser of the working fluid circuit to produce SH, DHW or both. The working fluid circuit includes an evaporator with tubing arrangement similar to that described in the previous aspect of the invention. In addition, the working fluid circuit includes at least an expander in fluid communication with the tubing such that the working fluid received from the tubing remains superheated after expansion in the expander, a condenser in fluid communication with the expander and a pump configured to circulate the working fluid.

Optionally, the heat source in the cogeneration system is a burner, and the elevated temperature primary fluid is an exhaust gas produced by the burner. Moreover, similar to the previous aspect, the heat transfer augmentation structure defines additional surface area on an outer surface of at least a portion of the distal stage, and is preferably in the form of a plurality of fins. In addition, the fins are preferably mounted on an outer surface of the tubing, and are defined by a high aspect ratio, where the dimension of the fin extending from the radial dimension of the tube is significantly greater than the fin thickness. In the present context, the fin length to thickness ratio of a high aspect ratio fin is preferably greater than ten, and more preferably greater than fifty, whereas a low aspect ratio is less than ten. The fins can be of the same or different material as the tubing and can be in intimate contact with the tubing or bonded to the tubing by welding or brazing, or the fins can be extruded directly from the wall material of the tubing to make spiral fins of varying heights and aspect ratios. Preferably, the proximal stage is defined by a substantially uniform outer surface along its longitudinal dimension, such that it defines a generally cylindrical cross-section, as previously discussed. In addition, the expander is preferably a scroll expander. Preferably, the proximal stage is made from a robust material, such as stainless steel, while the distal stage is made from a second, higher thermal conductivity material, such as copper or a copper-based alloy. Depending on the temperature and pressure regime extant in the intermediate stage, at least a portion of the intermediate stage could be made from either the material used in the proximal stage or the material used in the distal stage. Furthermore, at least one of the at least one intermediate stage tubes can include fins mounted on the tube outer surface. The fins mounted on the outer surface of the intermediate stage tubing are preferably defined by an aspect ratio that is less than that of the distal stage.

The operating conditions, including maximum temperature and pressure of the cogeneration system's working fluid circuit are configured to be within the design range of the organic working fluid and the tubing in the evaporator. For example, when the working fluid is R-245fa, the maximum temperature of the working fluid should be kept under 350° F (177° C.). The maximum bulk or average temperature at the evaporator exit has been set to no more than 310° F. (154° C.) to allow for some margin between the maximum working temperature and the maximum temperature the fluid can withstand. Additionally, the fluid may experience localized heating which takes the temperature of the fluid near the tube walls above the average fluid temperature at that location. While it is necessary to have the fluid near the walls be at a higher temperature than the bulk temperature so that heat transfer can occur, it is important to keep the highest fluid temperature low enough so that the fluid does not experience thermal breakdown. Similarly, the maximum working temperature of copper tubes up to 1½ inches (3.81 centimeters) diameter at 400 psi (2.76 MPa) internal pressure is 400° F. (204° C.). A controller can be incorporated to monitor and, if necessary, change operating parameters within the system. Switches, sensors and valves can be incorporated into the system to help the controller carry out its function.

According to another aspect of the present invention, a dwelling configured to provide at least a portion of the heat and power needs of occupants therein by using a cogeneration system is disclosed. The dwelling includes a plurality of walls defining at least one room between them, a roof situated above the walls, at least one ingress/egress (such as a door, window or similar opening) to facilitate passage into and out of the dwelling, and a cogeneration system in heat and power communication with the room. As with the previous embodiment, the cogeneration system includes a working fluid circuit configured to transport an organic working fluid, and at least one energy conversion circuit operatively responsive to the working fluid circuit such that upon operation of the cogeneration system, the energy conversion circuit is configured to provide useable energy as previously described. Additional componentry, such as an expander, condenser and pump are similar to those previously described. Optional features regarding the burner, exhaust gas produced by the burner, and fins placed on various parts of the tubing are as previously described. Another option includes a controller, such as a thermostat, that is responsive to occupant input.

According to yet another aspect of the present invention, a method of producing heat and electrical power from a cogeneration system is disclosed. The first step of the method involves configuring the cogeneration system to include a working fluid circuit for transporting an organic working fluid and at least one energy conversion circuit operatively responsive to the working fluid circuit such that it can provide useable energy. The organic working fluid is then superheated via heat exchange relationship in the evaporator, after which it gets expanded, during which the organic working fluid is maintained in the superheated state at least until after it has passed through the expander. The expander is configured such that during the expansion process, a generator operatively responsive to the expander can produce electricity. After passing through the expander, at least a portion of the excess heat from the organic working fluid is exchanged in the condenser, after which the organic working fluid can be pumped to be returned to the evaporator such that the cycle can be repeated. The evaporator is configured to convert the organic working fluid from a subcooled liquid into the superheated vapor, and includes the heat source, enclosure and tubing as previously discussed. As before, the heat source can be a burner and the elevated temperature primary fluid can be an exhaust gas produced by the burner.

According to still another aspect of the present invention, a Rankine cycle micro combined heat and power system is disclosed. The system includes a working fluid circuit and at least one energy conversion circuit operatively responsive to the working fluid circuit such that upon operation of the system, the energy conversion circuit is configured to provide useable energy. The working fluid circuit comprises an organic working fluid, evaporator, fluid-carrying conduit at least a portion of which is fluidly coupled to tubing within the evaporator, an expander in fluid communication with the conduit such that the received organic working fluid remains superheated after the expansion in the expander, a condenser in fluid communication with the expander, and a pump configured to circulate the organic working fluid through at least the conduit, expander and condenser. The evaporator includes a burner as the heat source, an enclosure including a heating chamber and a primary fluid flowpath where the heating chamber can transport excess heat from the burner to the flowpath, and tubing disposed within the flowpath and adjacently spaced relative to the burner such that heat transferred to the tubing during burner operation is sufficient to superheat the organic working fluid passing through the tubing. The tubing is grouped into a plurality of stages including a proximal stage disposed closest to the heat source such that at least a portion of proximal stage is configured to be in co-flow relationship with the elevated temperature primary fluid, at least one intermediate stage in fluid communication with and disposed downstream in the flowpath from the proximal stage such that the intermediate stage is exposed to lower temperature elevated temperature primary fluid than the proximal stage, and a distal stage disposed downstream in the flowpath from the intermediate stage (or stages) such that the distal stage is exposed to lower temperature elevated temperature primary fluid than the intermediate stage. At least a portion of the distal stage is configured to be in counterflow relationship with the elevated temperature primary fluid, and includes heat transfer augmentation structure, which could be, for example, fins. Preferably, the predetermined maximum is the maximum allowable temperature of the working fluid, which is typically set by the working fluid manufacturer. Optionally, at least one of the intermediate stage tubes may include fins mounted onto the tube outer surface, where these fins may be smaller than the ones used on the distal stage tubing.

### BRIEF DESCRIPTION OF THE SEVERAL VIEWS OF THE DRAWINGS

The following detailed description of the preferred embodiments of the present invention can be best understood when read in conjunction with the following drawings, where like structure is indicated with like reference numerals and in which:

FIG. 1 shows a schematic diagram of a micro-CHP system according to an embodiment of the present invention showing connection to external SH and DHW loops;

FIG. 2 shows a perspective view of an evaporator used in the micro-CHP of FIG. 1;

FIG. 3A shows the tubing stages and working fluid circuit path for a conventional counterflow evaporator;

FIG. 3B shows the tubing stages and working fluid circuit path for the evaporator of FIG. 2;

FIG. 4A shows a plot of temperature profiles of the evaporator tube walls and the working fluid flowing through the tubes for the evaporator circuit of FIG. 3B;

FIG. 4B shows a plot of the temperature profiles of FIG. 4A with the additional values for the exhaust gas;

FIG. 5A shows a typical temperature profile of a flue gas and working fluid when an evaporator tubing is circuited in a conventional counterflow arrangement;

FIG. 5B shows a typical temperature profile of a flue gas and working fluid when an evaporator tubing is circuited in a conventional co-flow arrangement;

FIG. 5C shows a temperature profile of a flue gas and working fluid when an evaporator tubing is circuited according to the evaporator of FIG. 2; and

FIG. 6 shows that electrical output is maximized when a cogeneration system is modulated according variable heat loads as compared to that of maintaining a constant heat load.

### DETAILED DESCRIPTION OF THE PREFERRED EMBODIMENTS

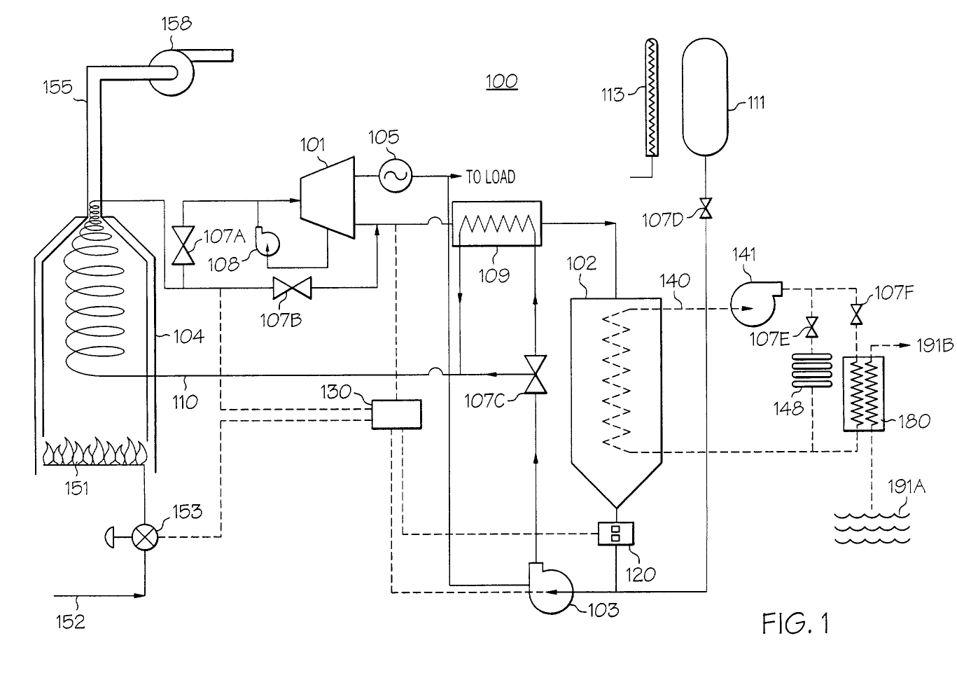

Referring initially to FIG. 1, a micro-CHP system 100 capable of providing electric current and heated fluid is shown. The system 100 includes a working fluid circuit and an energy conversion circuit. The working fluid circuit includes an expander 101, a condenser 102, a pump 103 and an evaporator 104. These four components define the major components that together approximate an ideal Rankine cycle system, where the evaporator 104 acts as a constant pressure heat addition, the expander 101 allows efficient, nearly isentropic expansion of the working fluid, the condenser 102 acts to reject heat at a constant pressure, and the pump 103 provides efficient, nearly isentropic compression. The evaporator 104, details of which will be discussed at length below, functions as the primary heat generator in micro-CHP system 100. In such a configuration, the heat (shown in the figure being produced by a combustion process where a fuel, such as natural gas, is transported via gas line 152 past gas valve 153 to a burner 151) in the evaporator is transferred to an organic working fluid being transported through conduit 110 (alternately referred to as piping). The energy produced by the expansion of the organic working fluid in the micro-CHP of the present invention is converted to electricity and heat. An exhaust gas recirculation (EGR) device 156 functions in conjunction with the exhaust duct 155 as part of exhaust gas heat exchanger 157. The hot exhaust gas stream is directed axially through the EGR device 156 and heat exchanger 157. The primary benefit of the EGR device 156 is that levels of harmful gaseous by-products (such as NOₓ) can be reduced. An optional fan 158 to pull away heat source byproducts is shown downstream of the heat source as an induced-draft fan, although it could also be a forced-draft fan if located upstream relative to the burner 151 and its ancillary componentry. A recuperator 109 is placed between expander 101 and condenser 102 in order to selectively extract additional heat from the working fluid once the fluid has been expanded. An accumulator 111 and associated warming device 113 can be placed in system 100 to act as a working fluid storage device during periods of low fluid flow rates (such as during system startup) to minimize, among other things, cavitation of pump 103.

The energy conversion circuit takes the increased energy imparted to the working fluid in the working fluid circuit and converts it into useable form. The electrical form of the useable energy comes from a generator 105 (preferably induction type) that is coupled to expander 101. Preferably, generator 105 is an asynchronous generator such that it always supplies maximum possible power without controls, as its torque requirement increases rapidly when generator 105 exceeds system synchronous speed. The generator 105 is started as a motor, by simply connecting it to line power from the utility grid. Those skilled in the motor art will understand that various means may be employed to limit the inrush of current into the motor during starting, should this be desirable. Once the motor is line connected, the grid can provide a reactive current for generator 105 excitation. If the expander 101 is then supplied with high pressure, high temperature vapor, the expander 101 will begin to drive the motor causing it to generate power as soon as the generator 105 exceeds the synchronous speed for the system, usually 3000 rpm for European systems or 3600 for systems in the United States. If the expander 101, generator 105 and local electrical load are chosen properly, the generator 105 can be safely and efficiently operated without speed or load controls. Up to the limits of the output capability of expander 101, all the expander power is converted into electricity by the generator 105, and used by the load. As the power increases, the speed of the expander 101 and generator 105 increases slightly, also, from perhaps 3050 rpm at low power to 3150 rpm at high power. Typical applications will have the generator 105 connected to the grid at the site of a local load, where the local load almost always exceeds the capacity of the micro-CHP system 100 to make power. Thus, the micro-CHP system 100 reduces, but seldom eliminates the local consumption of grid power. This may offer significant economic benefits by reducing to a minimum excess power from the micro-CHP that might have to be sold back to the utility, since utility rates for such power are often too low to be attractive. Oversight control of individual micro-CHP units to prevent generation of power at certain times of the day, or night, can be accomplished with an appropriately programmed internal clock. Utility oversight control for a population of units can be accomplished by remote controls as are used by utilities currently to control the use of water heaters during peak demand times.

The hot fluid form of the useable energy comes from a circulating fluid medium 140 (shown preferably as a combined SH and DHW loop) thermally coupled to condenser 102. Hydronic fluid flowing through circulating fluid medium 140 is circulated with a conventional pump 141, and can be supplied as space heat via radiator 148 or related device. As an example, hydronic fluid could exit the condenser 102 at about 112° F. (50° C.) and return to it as low as 86° F. (30° C.). The nature of the heat exchange process is preferably through either heat exchangers 180 (shown notionally for the DHW loop, but equally applicable to the SH loop), or through a conventional hot water storage tank (for a DHW loop). Isolation of either the SH or DHW loop within circulating fluid medium 140 is accomplished through valves 107E and 107F. It will be appreciated by those of ordinary skill in the art that while the embodiments depicted in the figures show DHW and SH heat exchangers in parallel (and in some circumstances being supplied from the same heat exchange device, shown later), it is within the spirit of the present disclosure that series or sequential heat exchange configurations could be used. It will also be appreciated that the heat exchanger 180 depicted in FIG. 1 could be in the form of the aforementioned hot water storage tank, where the hot fluid circulating through circulating fluid medium 140 gives up at least a portion of its heat to incoming domestic cold water coming from water supply 191A, which is typically from a municipal water source, well or the like. Once heated in the tank, the domestic water can then be routed to remote DHW locations, such as a shower, bath or hot water faucet, through DHW outlet 191B.

The organic working fluid (such as naturally-occurring hydrocarbons or halocarbon refrigerants, not shown) circulates through the working fluid circuit loop defined by the fluidly-connected expander 101, condenser 102, pump 103, evaporator 104 and conduit 110. The embodiment of the micro-CHP system 100 shown in FIG. 1 is operated as a directly-fired system, where the fluid that passes adjacent the heat source is also the working fluid passing through the expander 101. The condenser extracts excess heat from the organic working fluid after the fluid has been expanded such that circulating fluid loops hooked up to the condenser can absorb and transfer the heat to remote locations. While the expander 101 can be any type, it is preferable that it be a scroll device. For example, the scroll expander 101 can be based on a conventional single scroll device, as is known in the art. A scroll device exhibits numerous advantages over other positive-displacement systems. For example, since they are made in very high production volume in dedicated modem facilities, its cost is inherently low. Furthermore, the modification to an existing production line to convert from making scroll compressors to making scroll expanders is considerably simpler than to modify an existing reciprocating compressor production line, as the changes to valves and actuation are minimized. Additionally, by operating with very few moving parts, it can go long durations between service or component failure. Moreover, when operating in expansion mode, once the fixed volume of working fluid is captured, the nature of the working fluid-containing chamber is such that the volume of the chamber is always expanding. This also promotes long component life as it avoids the possibility of trapping and attempting to compress (such as upon a return stroke) a working fluid that could, under certain pressure and temperature regimes, include an incompressible liquid phase condensate. An optional oil pump 108 may be used to provide lubricant to the scroll. An optional level indicator switch 120 is placed at the discharge of condenser 102, while controller 130 is used to regulate system operation. Sensors connected to controller 130 measure key parameters, such fluid level information taken from the level indicator switch 120, and organic working fluid temperatures at various points within the organic working fluid circuit. Through appropriate program logic, it can be used to vary pump speed, gas flow rate and evaporator output temperature, as well as to open and close valves.

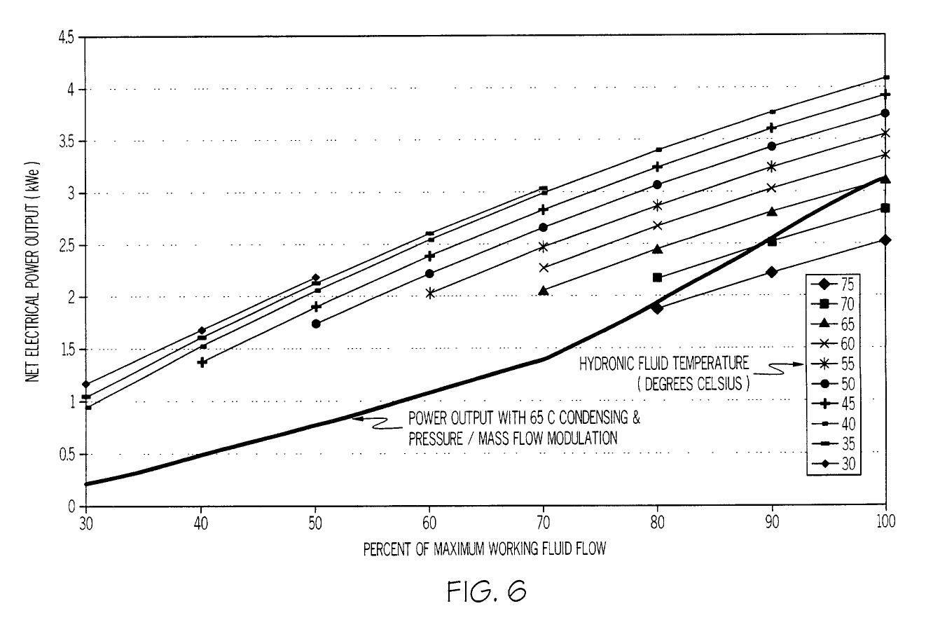

Referring next to FIG. 6 in conjunction with FIG. 1, a comparison between two ways to mimic the modulation of a boiler to achieve maximum system efficiency is shown. In many applications, where the set point of the system 100 is determined by a single parameter, such as an outdoor temperature, controller 130 can be used to provide primary control input to the evaporator 104. By operating the evaporator in a variable-capacity mode, where the gas valve 153 on the burner 151 can be modulated, the SH or DHW portions of the circulating fluid medium can be maintained at the desired set point. Such modulation permits quasi-steady state system operation that is responsive to heat needs that are keyed to a specified hydronic supply temperature set point, which is preferably the hydronic temperature coming off the condenser 102. For example, the ambient outdoor temperature is measured and sets the desired hydronic supply temperature. A single measuring point is used, preferably positioned on the building to avoid the influence of direct sunlight on cold days. A linear variation of the hydronic set point is used, so that on very cold days the hydronic set point is at or near its maximum setting (shown in the figure as 75° C.), while on warm days the set point is at or near its minimum (shown in the figure as 25° C.). The hydronic pump 141 operates continuously so there is always a flow through the system. Either an inverter drive or a separate input on the pump 103 would be sufficient to adjust the displacement of the pump 103 at constant motor speed to vary flow rate. The gas valve 153 is modulated to maintain the desired set point for the evaporator 104 outlet temperature of the working fluid into the expander 101. Properties of the working fluid, as well as of optional fluids, such as lubricants, may dictate maximum operating temperatures of the fluid coming out of the evaporator 104. For example, if the working fluid is the refrigerant known as R-245fa, the temperature set point at the evaporator 104 exit is about 310° F. (154° C.).

By operating the system such that the temperature of the working fluid at the evaporator 104 outlet is at or near its maximum value, good overall system efficiency results, regardless of system load. This can include very low thermal loads; for example, if the thermal load falls much below about 30 to 40% of full load, it is appropriate to shutdown the system and cease making both heat and power. Since the hydronic pump is kept running at all times, even at a low flow rate, the controller 130 can continuously monitor the error signal between the hydronic actual and set point values. When this error is large enough, (i.e., the actual temperature is below the set point by a preselected value) the controller 130 can start the system for another on-cycle. As the system 100 operates it may find that even at the minimum system mass flow, the actual supply temperature begins to exceed the set point. When this occurs, the system 100 is again shut down. Under this approach, the system 100 will operate for as many hours as possible during the colder heating season by running just often enough to maintain the hydronic supply temperature at the right value for the nominal heating load. When the system 100 operates at less than the maximum hydronic supply temperature, more power is generated than at the maximum temperature, so the controller 130 automatically and passively maximizes the electric power which can be produced. Thus, as shown in the figure, the net electrical output goes up (at the same working fluid mass flow rate) as hydronic fluid supply temperature requirements goes down, while variations in working fluid flow rate and can be used in conjunction to vary electric output under a given thermal load. This inherent flexibility promotes overall energy (electrical and heat) system efficiency.

Referring again to FIG. 1, the generator 105 is preferably an asynchronous device, thereby promoting simple, low-cost operation of the system 100, and reducing reliance on complex generator speed controls and related grid interconnections. An asynchronous generator always supplies maximum possible power without controls, as its torque requirement increases rapidly when generator 105 exceeds system frequency. The generator 105 can be designed to provide commercial frequency power, for example, 50 or 60 Hz, while staying within close approximation (often 150 or fewer revolutions per minute (rpm)) of synchronous speed (3000 or 3600 rpm). Block valve 107A and bypass valve 107B are situated in the organic working fluid flow path defined by conduit 110. These valves respond to a signal in controller 130 that would indicate if no load (such as a grid outage) were on the system, or if a high Q/P were desired, thus allowing the superheated vapor to bypass the expander, thereby transferring a majority of the excess heat to the heat exchange loop in the condenser 102 (for high Q/P operation), as well as additionally avoiding overspeed of expander 101.

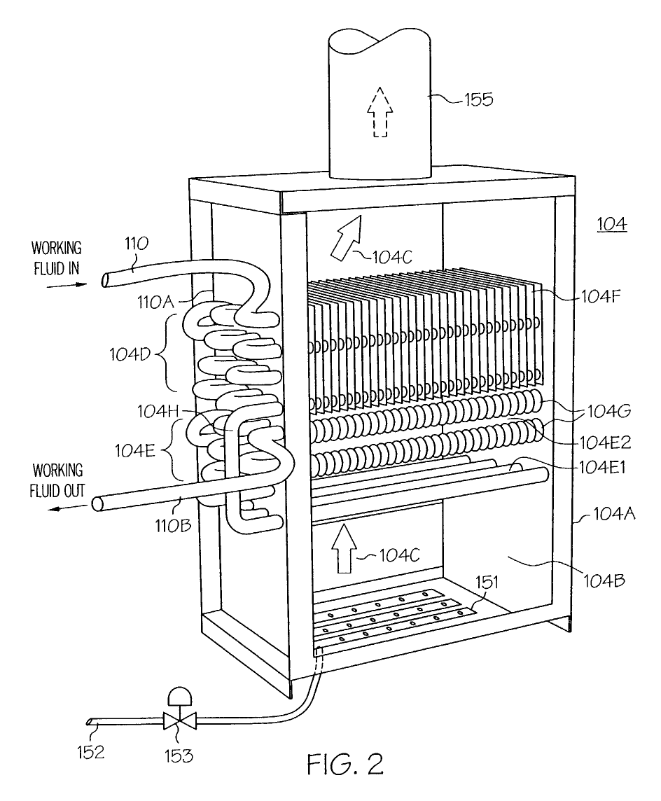

Referring next to FIG. 2, details of the evaporator 104 are discussed. Evaporator 104 includes an enclosure 104A that makes up the housing structure. Inside enclosure 104A is a heating chamber 104B shown with a heat source in the form of a burner 151 supplied with natural gas from gas line 152 and regulated by valve 153. In the heat source form shown, heat and products of combustion of the natural gas at burner 151 form a primary fluid (not shown) in the form of exhaust (or flue) gas that leaves heating chamber 104B via primary fluid flowpath 104C. It will be appreciated by those skilled in the art that although the configuration depicted in the figure preferably produces an exhaust gas, other forms of primary fluid are possible, such as warm air, chemical reaction byproduct gases, or other liquid or vapor (such as steam). Prior to exiting the evaporator 104 through exhaust duct 155, the exhaust gas passes over or around tubing that is fluidly connected to conduit 110 in the working fluid circuit. The tubing is divided up into a distal portion 104D and a proximal portion 104E, which itself may be subdivided into a first section 104E1 and a second section 104E2 the latter of which is situated between first section 104E1 and distal portion 104D. For the purposes of the present disclosure, the distal portion 104D and the two sections 104E1 and 104E2 of the proximal portion 104E are alternatively referred to as stages such that the distal portion 104D defines a distal stage, while the first section 104E1 of proximal portion 104E defines a proximal stage and the second section 104E2 of the proximal portion 104E defines an intermediate stage. Distal portion 104D may include many fins 104F or other surface area enhancements to promote additional heat transfer between the primary fluid flowing along flowpath 104C and the working fluid. Ideally, fins 104F are closely spaced and cover the entire heating chamber flowpath 104B to provide maximum heat transfer augmentation. Similarly, at least some of proximal portion 104E may include fins 104G which, if present, are more widely spaced and/or shorter than fins 104F associated with distal section 104D. The first section 104E1 of proximal portion 104E is made up of bare tubes (i.e., no attached fins), and these tubes are exposed to the hottest flue gas temperatures.

The choice of proper tube material depends primarily on the temperature regime outside the first section 104E1 and the pressure regime of the working fluid on the tube interior; if the operating conditions of the micro-CHP are such that the long-term structural integrity of the tubing of the first section 104E1 might be adversely affected, stronger, temperature-resistant materials, such as stainless steel, may be employed in place of higher thermal conductivity materials. However, it is possible that all of the tubing can be made from copper or a copper-based material, if, for example, all surface temperatures are maintained at 400° F. (204° C.) or below. By using bare tubes in first section 104E1 of proximal portion 104E, the heat transfer coefficient on the flue gas side of the tubes is much lower than the heat transfer coefficient on the working fluid side of the tubes. This disparity in heat transfer coefficients ensures that the ability of the working fluid to convey away the excess heat will dominate over the ability of the exhaust gas to impart heat to the first section 104E1, such that the temperature of the bare tubes will be much lower, limited to 400° F. (204° C.) or less for typical operating conditions of the disclosed micro-CHP. The length and spacing of the fins are adjusted to achieve an intermediate level of heat transfer rate from the flue gases to the second section 104E2 tubes. One parameter that can be varied is the fin aspect ratio, where tube spacing and heat transfer requirements determine if a high or low aspect ratio fin is required. The preferable aspect ratio of the fins (if present) in second section 104E2 is between five and twenty five, with a more preferable range between six and twelve. The flue gas temperature impinging on the second section 104E2 tubes is lower than that of the first section 104E1 tubes as a result of the significant thermal energy already transferred to the first section. Accordingly, the temperature regime that the second section 104E2 tube is exposed to may more easily allow the tube to be made from a high thermal conductivity material, such as copper or copper alloys, or a structurally robust stainless steel, in the event especially high strength or corrosion or temperature resistance is still required. The fins 104F of distal portion 104D are preferably made of a copper-based high thermal-conductivity material, as are the tubes making up distal portion 104D. In a preferred embodiment, the aspect ratio of fins 104F is greater than ten, and are more preferably greater than fifty, with an even more preferred aspect ratio of approximately sixty two and a half, based, for example, on a fin length of ½ inch (1.27 centimeters) and a thickness of eight one thousandths of an inch (3.15 thousandths of a centimeter). This stage has the highest heat transfer coefficient on the flue gas side of the heat exchanger, and the high heat transfer coefficient is necessary to achieve a high performance efficiency with a compact heat exchanger. The high heat transfer coefficients in distal portion 104D are possible without overheating the working fluid because the flue-gas temperatures are lower due to the heat absorbed by the first two sections 104E1, 104E2 of the proximal portion 104E.

Connection tube 104H bridges the tubing between distal and proximal portions 104D and 104E. The tubing is arranged such that the working fluid entering through conduit inlet 110A passes in counterflow relationship to the flue gas travelling along flowpath 104C through distal portion 104D, and then crosses at connection tube 104H into first section 104E1 of proximal portion 104E, where it then passes in co-flow relationship with the flue gas travelling along flowpath 104C, next through second section 104E2 of proximal portion 104E, then finally exiting evaporator 104 via conduit outlet 110B to the remainder of the working fluid circuit. In the co-flow portion of the tubing arrangement, both the exhaust gas and the working fluid flow from a region closer to the burner 151 to a region farther away, whereas in the counterflow arrangement, the working fluid is flowing from a region away from the burner 151 to a closer region. In both the counterflow and co-flow portions of the tubing arrangement, the working fluid traversing the tubes preferably moves across the hot exhaust path of heating chamber 104B multiple times at each axial location in substantially side-by-side tubing before moving on to another axial location in evaporator 104. This in effect manifests cross-counterflow and cross-co-flow of the working fluid relative to the hot exhaust path. In the present context, the use of the terms “counterflow” and “co-flow” will be understood to define the broadly the nature of the working fluid flow relative to the hot exhaust coming from the heat source, while the terms “cross-counterflow” and “cross-co-flow” define the more specific arrangement where multiple passes at each axial location take place within the tubing. The flue-gas temperature at each of the distal and proximal portions 104D, 104E of the heat exchanger can be controlled by the number of tubes in the adjacent stage or stages. Depending on the heat input rate of the burner 151 and the percent of excess air in the flue gases, the number of bare tubes in the first section 104E1 and the number of finned tubes in the second section 104E and distal portion 104D can vary. The number of tubes in each stage also depends on the maximum allowable operating temperature of the working fluid.

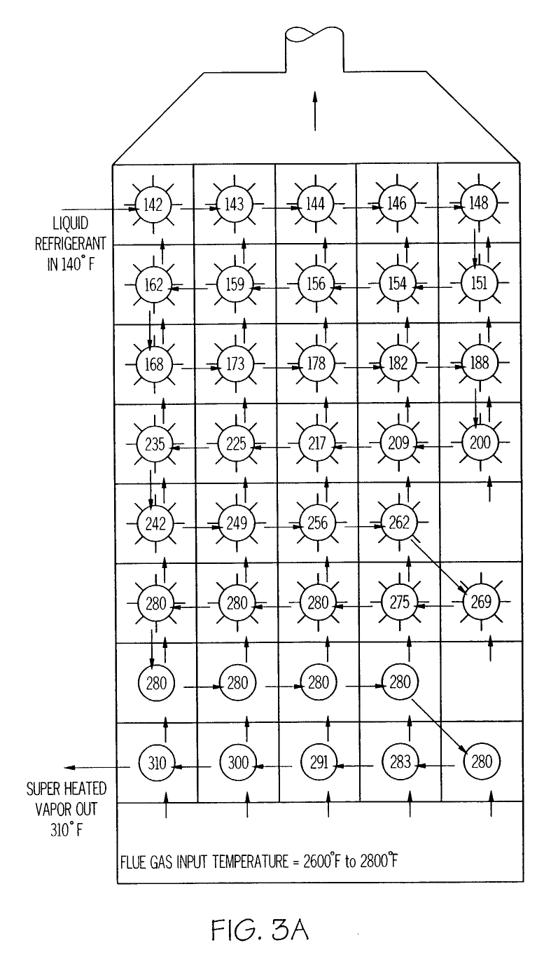

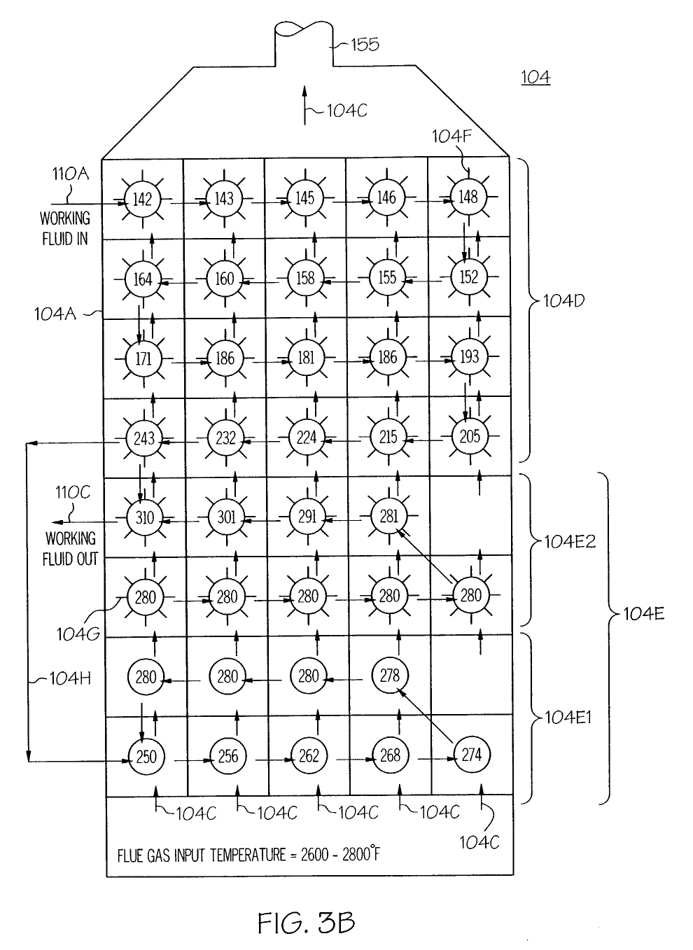

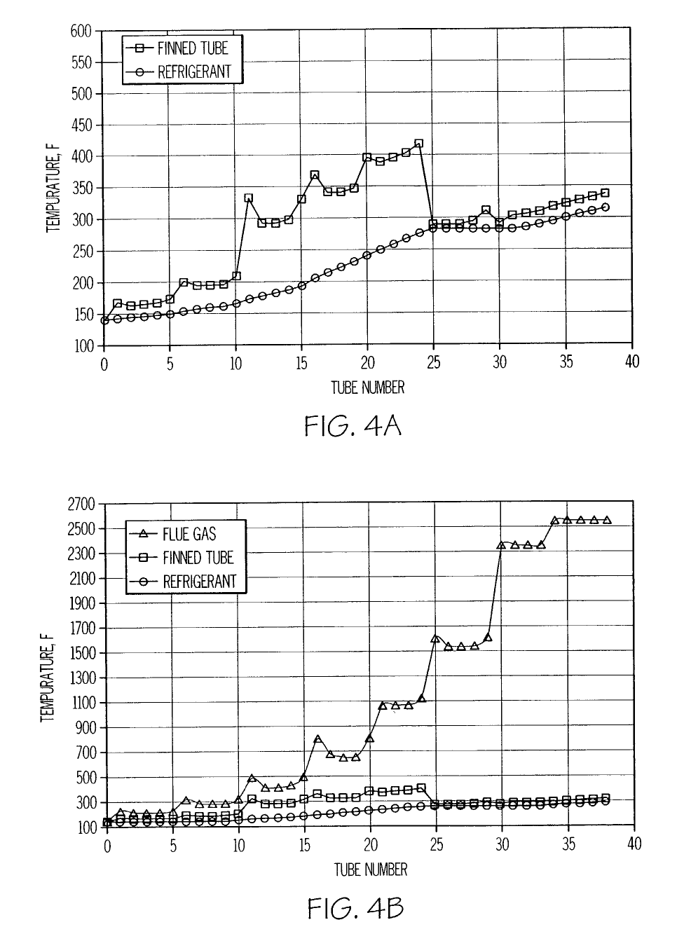

Referring next to FIGS. 3A, 3B, 4A and 4B, circuiting details are shown. Referring with particularity to FIG. 3A, the temperature profiles (in degrees Fahrenheit) are shown at each tube along a conventional counterflow evaporator. Each tube is notionally shown with a plurality of fins, represented by radially-projecting lines. Referring with particularity to FIGS. 3B, 4A and 4B, a schematic circuiting flow diagram (with tube temperature profiles) and related temperature plots are shown, respectively, with a stylized evaporator enclosure 104A representative of the hybrid circuiting approach of the present invention. The enclosure 104A houses numerous tubes such that both the distal portion 104D (to facilitate counterflow) and the proximal portion 104E (to facilitate co-flow) cooperate to provide the hybrid working fluid flow regime through evaporator 104. Connection tube 104H defines the transition from the distal portion 104D counterflow to proximal portion 104E co-flow. Optional fins 104F (for distal portion 104D) and 104G (for the second section 104E2 of proximal portion 104E) are, similar to FIG. 3A, represented notionally as lines in the figure, although it will be appreciated by those skilled in the art that fins are preferably two-dimensional objects, and can be formed from continuous discs, a continuous or semi-continuous helix, or segmented tabs. As shown with particularity in FIGS. 4A and 4B, temperature plots of the tube number versus the working fluid temperature at that location is compared in the first graph, with the flue gas temperature overlaid in the second graph. By way of example, if the working fluid is the refrigerant known as R-245fa, it could enter the enclosure 104A at approximately 140° F. (60° C.), and exit at approximately 310° F. (154° C.), while the exhaust gas from the burner impinging on the first row of tubes may be in the range of 280° F. (1538° C.), and exiting from the last row of tubes in the range of 300° F. (149° C.).

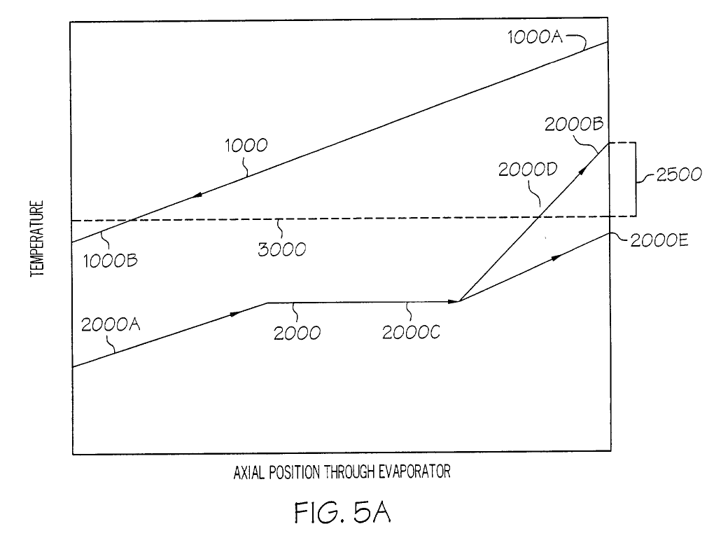

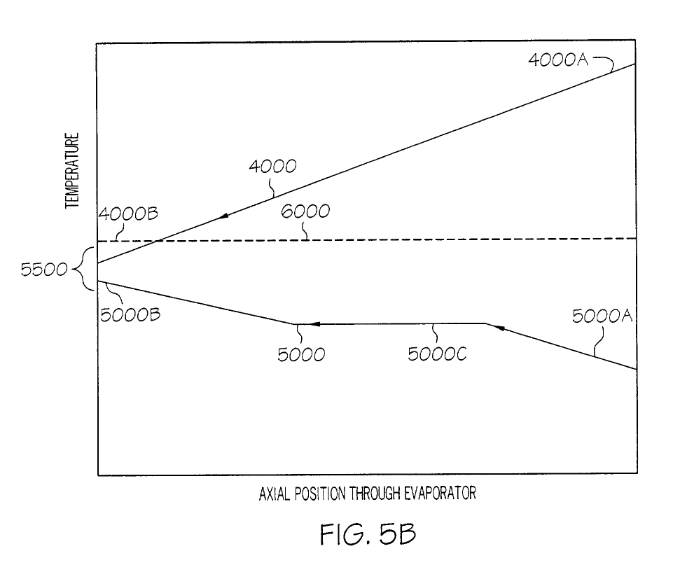

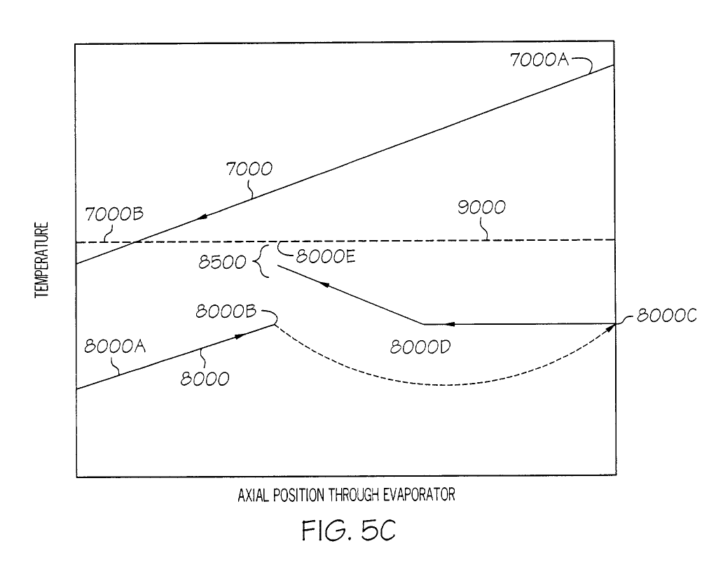

Referring next to FIG. 5A, the effects of a conventional exhaust gas and working fluid counterflow arrangement are shown. The abscissa along each graph corresponds to the axial position through the evaporator 104 (not presently shown) such that the left side is the region most downstream of the heat source, while the region nearest the heat source is on the right. The ordinate corresponds to temperature, as lower temperatures are near the bottom, and higher temperatures near the top. Line 1000 represents the temperature profile of the primary fluid as it leaves the heat source at location 1000A and proceeds to the exhaust duct 155 (not presently shown) at location 1000B. Conversely, line 2000 represents the temperature profile of the working fluid as it enters the evaporator 104 (not presently shown) at location 2000A remote from the heat source, and proceeds to the exit at thermal locations 2000B and 2000E nearest the heat source. It will be appreciated from the nature of the parameters on the graph that thermal locations 2000B and 2000E merely indicate thermally separate locations, and have nothing to do with the separate physical location within the tube; accordingly, in this context, such thermal striation is merely indicative of a temperature gradient from the inside wall of the tube to the center of its internal flowpath. Dashed line 3000 is drawn horizontally across the graph to show the maximum allowable temperature for the working fluid. As previously mentioned, in the case of the refrigerant known as R-245fa, this temperature is 350° F. (177° C.). The reason for the bifurcation in temperatures at the superheated vapor exit at 2000B and 2000E is to emphasize that while a significant portion of the working fluid vapor exits the evaporator at location 2000E, well below the maximum allowable temperature shown by dashed line 3000 for the working fluid, the portion of the velocity profile within the tube is such that a portion of the fluid closer to the tube wall is closer to temperature shown at location 2000B. The region 2000C along working fluid temperature profile 2000 where the temperature plateaus corresponds to the change of state of the working fluid from a liquid (where subcooled liquid is represented on the line from its inception point at location 2000A to the onset of the plateau) through bulk boiling (along the plateau) to incipient bulk superheated vapor (where superheating is represented on the line upward between the plateau and exit location 2000E). To achieve the high efficiency of heat transfer inherent in counterflow arrangements, the working fluid bulk temperature approaches, but does not exceed, its maximum allowable as shown at dashed line 3000. However, even when the bulk temperature does not exceed the maximum allowable, the temperature of that fluid nearest the tube wall will be higher and may exceed the maximum allowable at and beyond location 2000D. As a practical matter, this limits how much heat can be transferred. Temperature difference 2500 along the ordinate shows how much the maximum allowable temperature is exceeded by some of the fluid by the time the working fluid exits the evaporator 104. If this condition is not countered, it can lead to premature breakdown of the working fluid.

Referring next to FIG. 5B, the effects of conventional co-flow between the exhaust gas and the working fluid are shown. The graph abscissa and ordinate are as with the graph of FIG. 5A. Line 4000 represents the temperature profile of the primary fluid as it leaves the heat source at location 4000A and proceeds to the exhaust duct 155 (not presently shown) at location 4000B, as previously shown and described. However, unlike the counterflow arrangement of FIG. 5A, line 5000 now represents the temperature profile of the working fluid as it enters the evaporator 104 (not presently shown) at location 5000A nearest the heat source, and proceeds to the exit at location 5000B farthest away from the heat source. As before, dashed line 6000 is drawn horizontally across the graph to show the maximum allowable temperature for the working fluid. The plateau region 5000C along working fluid temperature profile 5000 is the temperature profile corresponding to the change of state of the working fluid from a liquid through bulk boiling (along the plateau) to incipient bulk superheated vapor. In conventional co-flow, there is a temperature gap 5500, called the pinch temperature, that represents a small but finite difference in the exit temperatures of the primary fluid 4000 and the working fluid 5000. While this pinch temperature is below the working fluid maximum allowable temperature 6000 such that harm to the working fluid is avoided, its mere presence at the flue gas exit end of the evaporator is a limitation on evaporator efficiency. Typically, the working fluid exit temperature is limited to the flue gas exit temperature less the minimum pinch temperature.

Referring next to FIG. 5C, the effects of the hybrid co-flow and counterflow circuiting according to the present invention are shown. The abscissa and ordinate of the graph are similar to that of FIGS. 5A and 5B, as is the working fluid maximum allowable temperature 9000. Similar to the profile shown in FIGS. 5A and 5B, line 7000 represents the temperature profile of the primary fluid as it leaves the heat source at location 7000A and proceeds to the exhaust duct 155 (not presently shown) at location 7000B. Line 8000 represents the temperature profile of the working fluid as it enters the evaporator 104 (not presently shown) at location 8000A remote from the heat source in the proximal portion 104D (not presently shown) of the tubing in a manner similar to that of the counterflow arrangement shown in FIG. 5A, and proceeds to a point 8000B where the subcooled working fluid is nearly a saturated liquid. At this location in the tubing, the working fluid is circuited to the proximal portion 104E (beginning at location 8000C) to be exposed to the hottest flue gas in co-flow relationship until it exits the evaporator at location 8000E. As before, the plateau region between 8000C and 8000D corresponds to the bulk boiling and consequent change of state of the working fluid, while the region between 8000D and 8000E corresponds to superheating of the working fluid. At the location 8000E of working fluid exit, the flue gas temperature has been reduced to the point that the working fluid cannot be overheated, as shown by the temperature difference 8500. Such working fluid path allows for optimum heat exchanger efficiency, preferably allowing the working fluid to heat up near the saturated liquid point.

Having described the invention in detail and by reference to preferred embodiments thereof, it will be apparent that modifications and variations are possible without departing from the scope of the invention defined in the appended claims. More specifically, although some aspects of the present invention are identified herein as preferred or particularly advantageous, it is contemplated that the present invention is not necessarily limited to these preferred aspects of the invention.

We claim:

1. An evaporator comprising:
a heat source configured to produce an elevated temperature primary fluid;
an enclosure defining a primary fluid flowpath therein such that said primary fluid flowpath is in thermal communication with said heat source; and
tubing disposed within said flowpath and spaced relative to said heat source such that during operation of said heat source at least a portion of the heat generated therefrom passes adjacent said tubing to superheat an organic working fluid therein, said tubing grouped in a plurality of stages including:
a proximal stage disposed closest to said heat source, said proximal stage comprising a first material;
at least one intermediate stage disposed downstream in said flowpath from said proximal stage; and
a distal stage disposed downstream in said flowpath from said at least one intermediate stage, said distal stage comprising a second material different from said first material and including heat transfer augmentation structure disposed thereon.

2. An evaporator according to claim 1, wherein said first material is stainless steel.

3. An evaporator according to claim 1, wherein said second material is predominantly copper.

4. An evaporator according to claim 1, wherein said proximal stage is defined by a substantially uniform outer surface along a longitudinal dimension thereof.

5. An evaporator according to claim 1, wherein said heat transfer augmentation structure defines additional surface area on an outer surface of at least a portion of said distal stage.

6. An evaporator according to claim 5, wherein said additional surface area on an outer surface of at least a portion of said distal stage comprises a plurality of fins.

7. An evaporator according to claim 6, wherein said plurality of fins mounted on an outer surface of said distal stage tubing are defined by an aspect ratio greater than ten.

8. An evaporator according to claim 6, wherein said plurality of fins mounted on an outer surface of said distal stage tubing are defined by an aspect ratio between fifty and seventy.

9. A cogeneration system comprising:
a working fluid circuit configured to transport an organic working fluid, said working fluid circuit comprising:
an evaporator comprising:
a heat source configured to produce an elevated temperature primary fluid;
an enclosure including a heating chamber and a primary fluid flowpath, said heating chamber configured to transport excess heat from said heat source to said flowpath; and
tubing disposed within said flowpath and adjacently spaced relative to said heat source such that during heat source operation heat transferred therefrom is sufficient to superheat said organic working fluid passing through said tubing, said tubing grouped in a plurality of stages including:
a proximal stage disposed closest to said heat source, said proximal stage comprising a first material;
at least one intermediate stage disposed downstream in said flowpath from said proximal stage such that said intermediate stage is exposed to lower temperature elevated temperature primary fluid than said proximal stage; and
a distal stage disposed downstream in said flowpath from said at least one intermediate stage such that said distal stage is exposed to lower temperature elevated temperature primary fluid than said at least one intermediate stage, said distal stage comprising a second material and including heat transfer augmentation structure disposed thereon;
an expander in fluid communication with said tubing such that said organic working fluid received therefrom remains superheated after expansion in said expander;
a condenser in fluid communication with said expander; and
a pump configured to circulate said organic working fluid through at least said evaporator, expander and condenser; and
at least one energy conversion circuit operatively responsive to said working fluid circuit such that upon operation of said cogeneration system, said at least one energy conversion circuit is configured to provide useable energy.

10. A cogeneration system according to claim 9, wherein said heat source is a burner.

11. A cogeneration system according to claim 9, wherein said elevated temperature primary fluid is an exhaust gas produced by said burner.

12. A cogeneration system according to claim 9, wherein said proximal stage is defined by a substantially uniform outer surface along a longitudinal dimension thereof.

13. A cogeneration system according to claim 9, wherein said first material is different than said second material.

14. A cogeneration system according to claim 13, wherein said first material is stainless steel.

15. A cogeneration system according to claim 13, wherein said second material is predominantly copper.

16. A cogeneration system according to claim 9, wherein at least a portion of said at least one intermediate stage tubing is selected from the group consisting of said first material and said second material.

17. A cogeneration system according to claim 16, wherein at least a portion of said at least one intermediate stage tubing includes a plurality of fins mounted on an outer surface thereof.

18. A cogeneration system according to claim 17, wherein said plurality of fins mounted on said outer surface of said intermediate stage tubing are defined by an aspect ratio between five and twenty five.

19. A cogeneration system according to claim 9, wherein said distal stage tubing comprises copper.

20. A micro combined heat and power system comprising:
a working fluid circuit configured to transport an organic working fluid, said working fluid circuit comprising:
a heat source configured to produce an elevated temperature primary fluid;
an enclosure defining a primary fluid flowpath therein such that said primary fluid flowpath is in thermal communication with said heat source; and
tubing disposed within said flowpath and spaced relative to said heat source such that during operation of said heat source at least a portion of the heat generated therefrom passes adjacent said tubing to superheat an organic working fluid therein, said tubing grouped in a plurality of stages including:
a proximal stage disposed closest to said heat source;
at least one intermediate stage disposed downstream in said flowpath from said proximal stage; and
a distal stage disposed downstream in said flowpath from said at least one intermediate stage, said distal stage including heat transfer augmentation structure disposed thereon;
an expander in fluid communication with said tubing such that said organic working fluid received therefrom remains superheated after expansion in said expander;
a condenser in fluid communication with said expander; and
a pump configured to circulate said organic working fluid through at least said evaporator, expander and condenser; and
at least one energy conversion circuit operatively responsive to said working fluid circuit such that upon operation of said cogeneration system, said at least one energy conversion circuit is configured to provide useable energy.

21. A micro combined heat and power system according to claim 20, wherein said proximal stage is made from a different material than said distal stage.

22. A micro combined heat and power system according to claim 20, wherein said proximal stage and distal stages are comprised of a material that is at least predominantly copper.

23. A micro combined heat and power system according to claim 20, wherein said proximal stage is defined by a substantially uniform outer surface along a longitudinal dimension thereof.

24. A micro combined heat and power system according to claim 20, wherein said heat transfer augmentation structure defines additional surface area on an outer surface of at least a portion of said distal stage.

25. A micro combined heat and power system according to claim 24, wherein said additional surface area comprises a plurality of fins.

26. A micro combined heat and power system according to claim 25, wherein said plurality of fins are defined by an aspect ratio between fifty and seventy.

27. A micro combined heat and power system according to claim 24, further comprising additional surface area on an outer surface of at least a portion of said intermediate stage.

28. A micro combined heat and power system according to claim 27, wherein said additional surface area on an outer surface of at least a portion of said intermediate stage comprises a plurality of fins.

29. A dwelling configured to provide at least a portion of the heat and power needs of occupants therein, said dwelling comprising:
a plurality of walls defining at least one room therebetween;
a roof situated above said plurality of walls;
at least one ingress/egress to facilitate passage into and out of said dwelling; and
a cogeneration system in heat and power communication with said at least one room, said cogeneration system comprising:
a working fluid circuit configured to transport an organic working fluid, said working fluid circuit comprising:
an evaporator comprising:
a heat source configured to produce an elevated temperature primary fluid;
an enclosure including a heating chamber and a primary fluid flowpath, said heating chamber configured to transport excess heat from said heat source to said flowpath; and
tubing disposed within said flowpath and adjacently spaced relative to said heat source such that during heat source operation heat transferred therefrom is sufficient to superheat said organic working fluid passing through said tubing, said tubing grouped in a plurality of stages including a proximal stage disposed closest to said heat source, at least one intermediate stage disposed downstream in said flowpath from said proximal stage such that said intermediate stage is exposed to lower temperature elevated temperature primary fluid than said proximal stage, and a distal stage disposed downstream in said flowpath from said at least one intermediate stage such that said distal stage is exposed to lower temperature elevated temperature primary fluid than said at least one intermediate stage, said distal stage including heat transfer augmentation structure disposed thereon;
an expander in fluid communication with said tubing such that said organic working fluid received therefrom remains superheated after expansion in said expander;
a condenser in fluid communication with said expander; and
a pump configured to circulate said organic working fluid through at least said evaporator, expander and condenser; and
at least one energy conversion circuit operatively responsive to said working fluid circuit such that upon operation of said cogeneration system, said at least one energy conversion circuit is configured to provide useable energy.

30. A dwelling according to claim 29, wherein said heat source is a burner.

31. A dwelling according to claim 30, wherein said elevated temperature primary fluid is an exhaust gas produced by said burner.

32. A dwelling according to claim 29, wherein said heat transfer augmentation structure defines additional surface area on an outer surface of at least a portion of said distal stage.

33. A dwelling according to claim 32, wherein said additional surface area on an outer surface of at least a portion of said distal stage comprises a plurality of fins.

34. A dwelling according to claim 29, further comprising a controller in signal communication with a temperature sensor.

35. A dwelling according to claim 34, wherein said controller is responsive to occupant input.

36. A dwelling according to claim 34, wherein said controller responsive to occupant input is a thermostat.

37. A method of producing heat and electrical power from a cogeneration system, the method comprising the steps of:
configuring said cogeneration system to include:
a working fluid circuit configured to transport an organic working fluid, said working fluid circuit comprising:
a pump configured to circulate said organic working fluid through said working fluid circuit;
an evaporator configured to convert said organic working fluid from a subcooled liquid into a superheated vapor, said evaporator comprising:
a heat source configured to produce an elevated temperature primary fluid;
an enclosure including a heating chamber and a primary fluid flowpath, said heating chamber configured to transport excess heat from said heat source to said flowpath; and
tubing disposed within said flowpath and adjacently spaced relative to said heat source such that during heat source operation heat transferred therefrom is sufficient to superheat said organic working fluid passing through said tubing, said tubing grouped in a plurality of stages including a proximal stage disposed closest to said heat source, at least one intermediate stage disposed downstream in said flowpath from said proximal stage such that said intermediate stage is exposed to lower temperature elevated temperature primary fluid than said proximal stage, and a distal stage disposed downstream in said flowpath from said at least one intermediate stage such that said distal stage is exposed to lower temperature elevated temperature primary fluid than said at least one intermediate stage, said distal stage including heat transfer augmentation structure disposed thereon;
an expander in fluid communication with said tubing such that said organic working fluid received therefrom remains superheated after expansion in said expander; and
a condenser in fluid communication with said expander; and
at least one energy conversion circuit operatively responsive to said working fluid circuit such that upon operation of said cogeneration system, said at least one energy conversion circuit is configured to provide useable energy;
superheating said organic working fluid in said evaporator;
expanding said superheated organic working fluid to generate electricity;
maintaining said organic working fluid in said superheated state at least until after said organic working fluid has passed through said expander;
exchanging at least a portion of the excess heat from said organic working fluid in said condenser; and
returning said organic working fluid to said evaporator.

38. A method according to claim 37, wherein said heat source is a burner.

39. A method according to claim 38, wherein said elevated temperature primary fluid is an exhaust gas produced by said burner.

40. A method according to claim 37, wherein said heat transfer augmentation structure defines additional surface area on an outer surface of at least a portion of said distal stage.

41. A method according to claim 40, wherein said additional surface area on an outer surface of at least a portion of said distal stage comprises a plurality of fins.

42. A method according to claim 37, wherein said proximal stage is defined by a substantially uniform outer surface along a longitudinal dimension thereof.

43. A Rankine cycle micro combined heat and power system comprising:
a working fluid circuit comprising:
an organic working fluid;
an evaporator comprising:
a burner configured to produce an elevated temperature primary fluid;
an enclosure including a heating chamber and a primary fluid flowpath, said heating chamber configured to transport excess heat from said burner to said flowpath; and
tubing disposed within said flowpath and adjacently spaced relative to said burner such that during burner operation heat transferred therefrom is sufficient to superheat said organic working fluid passing through said tubing, said tubing grouped in a plurality of stages including:
a proximal stage disposed closest to said burner such that at least a portion of proximal stage is configured to be in co-flow relationship with said elevated temperature primary fluid, said proximal stage comprising a first material;
at least one intermediate stage in fluid communication with and disposed downstream in said flowpath from said proximal stage such that said intermediate stage is exposed to lower temperature elevated temperature primary fluid than said proximal stage; and
a distal stage disposed downstream in said flowpath from said at least one intermediate stage such that said distal stage is exposed to lower temperature elevated temperature primary fluid than said at least one intermediate stage, at least a portion of said distal stage is configured to be in counterflow relationship with said elevated temperature primary fluid, said distal stage comprising a second material different from said first material and including heat transfer augmentation structure disposed thereon;
conduit configured to transport an organic working fluid through said working fluid circuit, at least a portion of said conduit fluidly coupled to said tubing;
an expander in fluid communication with said conduit such that said organic working fluid received therefrom remains superheated after said expansion in said expander;
a condenser in fluid communication with said expander; and
a pump configured to circulate said organic working fluid through at least said conduit, expander and condenser; and
at least one energy conversion circuit operatively responsive to said working fluid circuit such that upon operation of said system, said at least one energy conversion circuit is configured to provide useable energy.

44. A Rankine cycle micro combined heat and power system according to claim 43, wherein said predetermined maximum is the maximum allowable temperature of said working fluid.

45. A Rankine cycle micro combined heat and power system according to claim 43, wherein at least one of said at least one intermediate stage tubing includes a plurality of fins mounted on an outer surface thereof.

46. A Rankine cycle micro combined heat and power system according to claim 43, wherein said heat transfer augmentation structure comprises a plurality of fins disposed on at least a portion of said distal stage.
